(19) United States
(12) Patent Application Publication
(10) Pub. No.: US 2025/0017152 A1
(43) Pub. Date: Jan. 16, 2025

(54) ABOVE GROUND WATERING SYSTEM FOR VANDACEOUS ORCHIDS

(71) Applicant: Kosei Weber, Nendaz (CH)

(72) Inventor: Kosei Weber, Nendaz (CH)

(21) Appl. No.: 18/786,441

(22) Filed: Jul. 27, 2024

Related U.S. Application Data
(63) Continuation-in-part of application No. 17/736,115, filed on May 4, 2022, now abandoned.

(51) Int. Cl. A01G 22/63; A01G 31/02

(52) U.S. Cl. CPC A01G 22/63; A01G 31/02

(57) ABSTRACT

An above ground watering system for vandaceous orchid air plants. Some embodiments may comprise one or more watering elements, such as a watering manifold that may deliver water through one or more outtake ports through water delivery members that may extend from the watering manifold and ribbons wrapped around the roots of the vandaceous orchid to deliver water and/or nutrients continuously via capillary action.

### SUMMARY

Divided jardinière suspension and/or watering systems for vandaceous orchids, especially Strap-leaf Vandas (SLV) are disclosed herein. In some embodiments, the system may comprise two receptacle pieces that may be coupled together to define a complete receptacle for a vandaceous orchid. Some embodiments may further comprise one or more watering elements, such as a watering manifold that may deliver water through one or more outtake ports through water delivery members that may extend from the watering manifold and be wrapped around the roots of the vandaceous orchid to deliver water and/or nutrients continuously via capillary action. SLV are epiphytic non-terrestrial orchids, often grown without any potting media/soil (reference: Vanda Culture Sheet, American Orchid Society 2024). SLV are not the most common orchids grown in homes as roots often grow very long and tangly in search of water without media and even with media roots often still overgrow their pots, additionally vandas are recommended to be watered every 2 days (reference: Growing Vanda Orchids, Pacific Farmers, 2021 march). Watering a 1-2-foot (30-60 cm) SLV plant in a living room with dangling roots and no pot every other may be inconvenient for a homeowner, especially if going on vacation for some time. Some home Orchidists take their SLV's to the shower or bathtub to water but this may also be frustrating 150 times per year. Although some growers have the advantage of a greenhouse with humidity control and automatic watering, simple home growers may not. Additionally, in the winter, dryness from indoor heating, etc. may render growing SLV without frequent watering problematic. Having media in a pot usually requires changing the media over time as the media may rot, breakdown, or develop unwanted insects, bacteria or fungus. A system of an exterior shell to house the bulk of the roots and a gravitationally and/or capillary based wrapped wicking system for vanda roots may alleviate these problems. The system may also have the advantage of wrapping just a few roots to continually deliver water to a SLV without having to water the SLV via spray or bathing as described above. The forces of capillary action through a porous wick which may include the forces of adhesion, cohesion, and surface tension may not overcome evaporation and gravity over a given time in a system open to the air. Thus, a gravitationally dependent wick wrapped around a SLV root may deliver water to a length of a root before evaporation would remove the water, as opposed to an open-air wick oriented superiorly/above a water source. Some water wick systems in pots containing soil can be oriented superiorly/above the water source/inlet and supply water to roots above the inlet because soil reduces airflow, thus reducing evaporation, and soil may also be able to add its own forces of adhesion, cohesion, and surface tension around the zone of the wick.

For the purposes of this disclosure, the Vandaceous orchids concern those that are epiphytes, more commonly known as air plants; some Vandaceous orchids are terrestrial, more commonly known as growing in the earth/dirt. The system and its attendant materials are best suited to the more lightweight, airy nature of the Vandaceous epiphytic orchids (VEOs), especially SLV's as terrestrial orchid dirt would spill through any fibre or mesh or system with excessive air holes and weigh more, thereby complicating suspension. Others include Vanda, Ascocenda, Phalaenopsis, Rhyncostylis, Aerides. Vandaceous orchids are monopodial orchids which have a single stem which produces new leaves at its growing tip and roots lower down the stem. The leaves often form a fan shape with alternating opposing leaves pointing 180 degrees apart. The aesthetics of the leaves of Vandaceous orchids lend themselves to a relatively planar conformation with little of a ‘z-axis’ (depth) compared to relatively large x & y (width, height) components. A typical circular pot for plant (or orchid) growing has a z-axis equal to the x-axis which in the case of Vandaceous orchids may cost unnecessary space and conflict with the aesthetics of a linear plant. A cross-sectionally elliptical potting system, at least in part (preferably at least a portion of the region in which the roots grow is elliptical in shape) may be advantageous not only from space saving, especially in a home but from an aesthetic sense in that an ellipse has a minimized z-axis (less depth) matching the orchid's style of growth and habitus.

The Vandaceous orchid genus Phalaenopsis is one of the most popular orchid types grown in the world. However, Vanda, Ascocenda, Rhyncostylis and Renanthera are less so. They thrive in humid tropical rainforest like settings but struggle in homes outside the tropics or subtropics as heating and dryness may be deleterious. Such members of the Vandaceous orchids have long, gangly, sinuous roots that are also very delicate/sensitive to trauma and drying, often grow well beyond standard pots and fracture easily when bent. If they do grow well and produce many roots as typical of a healthy plant such orchids are often a nuisance to repot of grown in traditional clay pots, which often require breaking the pot to free the delicate roots or cutting a plastic pot. Having a system that clamps on from both sides may be advantageous in that uncooperative roots that cannot be bent may be allowed to exit a bottomless bottom or deliberately in-between a seam where parts of a potting system meet. Such a system may allow the convenience of re-potting such wieldy plants whilst they lay on their sides. Enhancing convenience of care and growth may allow for non-phalaenopsis vandaceous orchids to gain wider public acceptance.

According to one aspect of this invention, there is provided a jardinière suspension system for watering aerial roots of a vandaceous orchid, comprising:
a first receptacle piece;
a second receptacle piece coupleable with the first receptacle piece to form a complete receptacle for growing a vandaceous orchid therein, wherein the complete receptacle comprises a non-circular elliptical or non-circular semi-elliptical shape in cross-section, wherein the complete receptacle is open at the bottom and unable to hold soil;
at least one coupling piece for coupling the first receptacle piece to the second receptacle piece; and
a watering manifold having at least one watering outtake port for delivery of water to aerial roots of the vandaceous orchid; and
at least one water delivery member is configured to extend from the watering manifold, wherein any one water delivery member of the at least one water delivery member is configured to be wrapped spirally about an individual aerial root of the vandaceous orchid to deliver water continuously from the watering manifold via capillary action; and
wherein the at least one water delivery member is configured to depend from the manifold, whereby water passes through the at least one water delivery member gravitationally from the manifold, and wherein the at least one water delivery member is configured to wrap spirally around a vandaceous orchid aerial root and wherein the at least one water delivery member is configured to directly contact vandaceous orchid aerial roots.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A depicts a vandaceous orchid that may be used with one or more of the jardinière suspension and watering systems disclosed herein.

FIG. 1B depicts one piece of a divided jardinière suspension and gravity-dependent watering system having a vandaceous SLV orchid contained therein having an open-air-not-closed bottom, too large to hold media or soil, according to some embodiments.

FIG. 1C depicts a complete jardinière suspension and watering system having a vandaceous orchid contained therein according to some embodiments.

FIG. 1D depicts the half jardinière suspension and watering system with a watering manifold coupled therein.

FIG. 2A depicts one piece of a divided jardinière suspension and watering system having an open bottom along with a pair of coupling bands for coupling a second piece (not shown) of the jardinière according to some embodiments.

FIG. 2B depicts a split jardinière suspension and watering system having an open bottom and a hanging rod according to some embodiments.

FIG. 2C depicts the split jardinière suspension and watering system of FIG. 2b with openings to receive the hanging rod therethrough.

FIG. 2D depicts one piece of a divided jardinière suspension and watering system having a bottom with openings for roots of a vandaceous orchid to extend and/or grow therethrough according to some embodiments.

FIG. 3A depicts a jardinière suspension and watering system made with a fibrous material.

FIG. 3B depicts a fully coupled jardinière suspension and watering system with two pieces coupled together using a pair of coupling bands according to some embodiments.

FIG. 3C depicts an example of a coupling piece comprising a coupling band for a jardinière suspension and watering system.

FIGS. 4A-4D are top plan views of divided jardinière suspension and watering systems having different shapes according to some embodiments.

FIG. 5 depicts a divided jardinière suspension and watering system having one shaped piece and one flat piece according to some embodiments.

FIG. 6A depicts a watering manifold for a jardinière suspension and watering system according to some embodiments.

FIG. 6B depicts a stopper for an output port of a watering manifold for a jardinière suspension and watering system according to some embodiments.

FIG. 6C depicts a water delivery ribbon coupled to a stopper and wrapped around a root of a vandaceous orchid according to some embodiments.

FIG. 7A is a side view that depicts one piece of a divided jardinière suspension system comprised of molded plastic with aeration holes.

FIG. 7B is a top plan view that depicts an insertable bottom piece of a divided jardinière suspension system comprised of molded plastic with aeration holes.

FIG. 8A is a side view that depicts one piece of a divided jardinière suspension system comprised of metal woven mesh also showing some natural fibrous media incorporated therein.

FIG. 8B is a top plan view that depicts an insertable bottom piece of a divided jardinière suspension system comprised of metal woven mesh.

FIG. 9A is a side view that depicts a first piece of a divided jardinière suspension system comprised of metal woven mesh.

FIG. 9B is a side view that depicts a second piece of a divided jardinière suspension system comprised of metal woven mesh that is designed to fit against the first piece forming a sandwich area in between where a fibrous material may be positioned.

FIG. 9C is a cross-sectional view depicting the two pieces of a divided jardinière suspension system comprised of metal woven mesh wherein a fibrous material is being sandwiched and/or compressed in between the two pieces.

FIG. 10A is a side view showing an alternative receptacle piece comprising an elongated fibrous member.

FIG. 10B is a close-up cross-section view of a portion of the receptacle piece of 10A.

### DETAILED DESCRIPTION

Further details regarding various embodiments will now be provided with reference to the drawings.

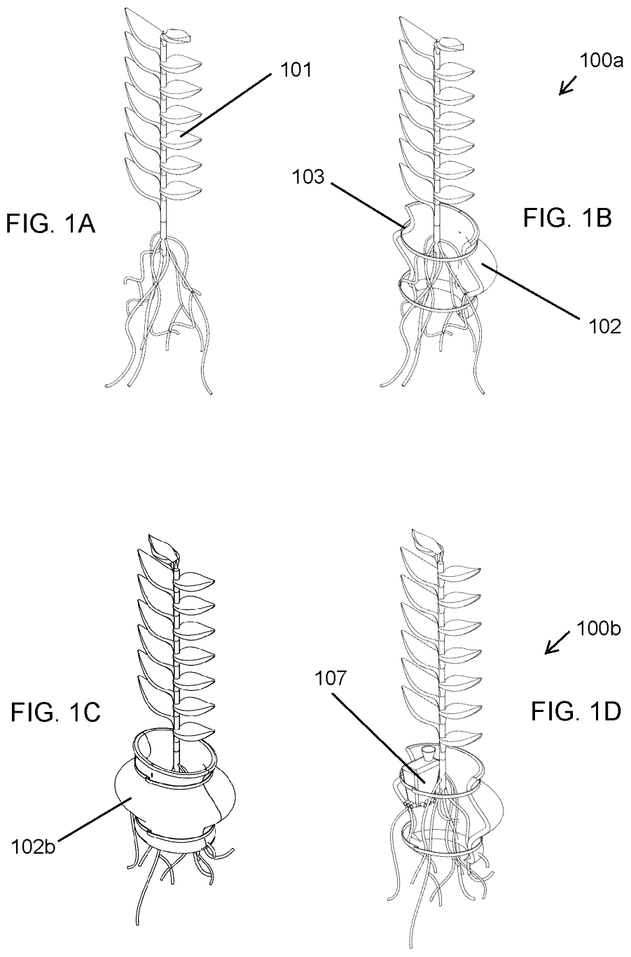

FIG. 1A depicts a vandaceous orchid 101 that may be used with one or more of the jardinière suspension and watering systems disclosed herein. The leaf structure of the example vandaceous orchid depicted is diminutive for illustrative purposes to save space and preserve the relative size of the system in question and somewhat represents Renanthera genus of the Orchid family with leaves radiating 180 degrees creating a fan shape which may measure 15 cm across. This is in contrast to the Vanda genus which may have a cross-leaf-to-leaf dimension of 60 cm (2 feet).

FIG. 1B depicts one piece 102 of a jardinière suspension and watering system 100a having a vandaceous orchid contained therein having an open bottom according to some embodiments. System 100a comprises a pair of coupling pieces 103 that may be used to couple a second half of system 100a (not shown in the figure) to form a complete jardinière or receptacle for vandaceous orchid 101. In the depicted embodiment, coupling pieces 103 comprise coupling bands. Suitable coupling bands may include, for example, iron bands or wires, rubber or other elastic bands, rope, string, and the like. In some embodiments, coupling pieces 103 may be open ended and may be wrapped about a portion of two receptacle pieces 102 of system 100a by tying, twisting, or otherwise securing the two loose ends. In other embodiments, coupling pieces 103 may comprise a complete band that may be stretched about the two pieces 102 to secure system 100a. In the depicted embodiment, the bottom of the receptacle is open to allow roots to grow therethrough. A watering system having an open bottom is known as an open system. An open system and its attendant materials are best suited to the more lightweight, airy nature of the Vandaceous epiphytic orchids (VEOs), especially SLV's, as heavy terrestrial orchid dirt or media would spill through open bottom. A dirt-less, media-less system weighs less, thereby facilitating suspension. Also, wet dirt and media is not containable in such an open system and may be undesirably spilled on a home floor.

FIG. 1C depicts a complete jardinière suspension and watering system 100a having a vandaceous orchid 101 contained therein according to some embodiments. As shown in this figure, a second receptacle piece 102b has been coupled to the piece shown in FIG. 1B using coupling pieces 103.

The embodiment shown in FIGS. 1B and 1C has a receptacle that is open at the bottom and unable to hold soil.

FIG. 1D depicts another jardinière suspension and watering system 100b having a vandaceous orchid contained therein. System 100b comprises a watering manifold 107 coupled therein, which, as described below, may be configured to deliver water, potentially with other nutrients via the gravitationally dependent fashion depicted and described for FIG. 6c, directly to the roots of the vandaceous orchid 101. The system 100b described herein is intended to be used without any potting soil, as a receptacle having an open bottom of the size depicted, to allow roots to grow therethrough, could not hold soil/media without unwanted spillage or loss. Thus, the embodiment shown in FIG. 1d has a receptacle that is open at the bottom and unable to hold soil.

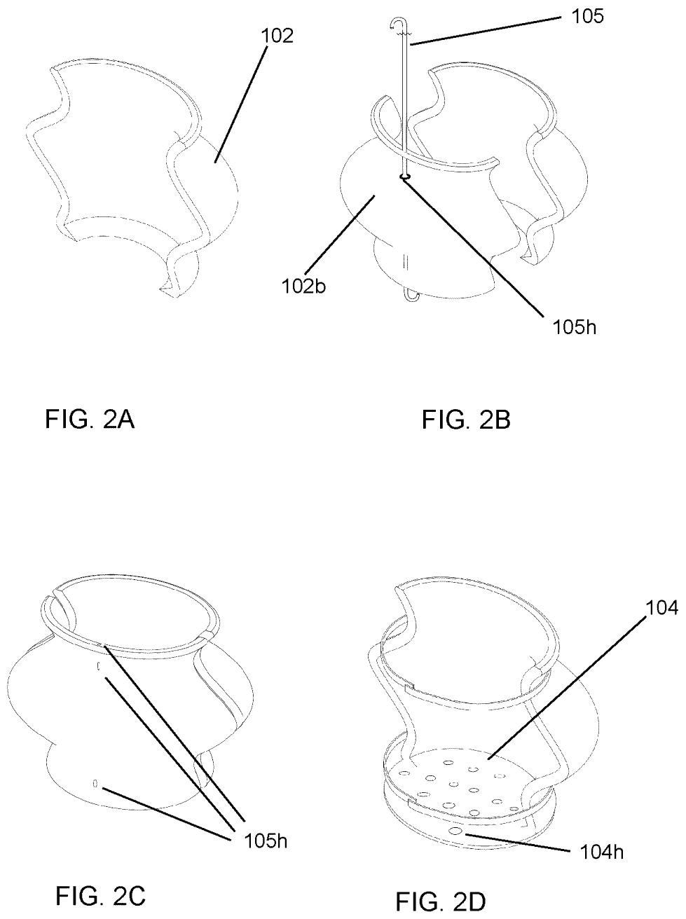

FIG. 2A depicts one receptacle piece 102 of a divided jardinière suspension and watering system along with a pair of coupling bands 103, as previously described, for coupling a second receptacle piece (not shown) of the jardinière according to some embodiments.

FIG. 2B depicts yet another embodiment of a divided jardinière suspension and watering system having an open bottom and a hanging rod 105 and holes 105h according to some embodiments. Rod 105 may comprise hooks or other coupling features at one or both ends to facilitate a stable connection with the receptacle and allow for hanging the system from a desired structure. In other embodiments, the system may be mounted to a wall, which may be particularly desirable in embodiments in which one of the pieces of the divided jardinière/receptacle is flat rather than shaped as shown in FIG. 2B. In some preferred embodiments, hanging rods are preferably made of metal and may be coated with silver or other metals or plastics that are nontoxic and antimicrobial. In some preferred embodiments, hanging rods may measure about 4 mm in diameter and about 70 cm long. In other embodiments, hanging rods may vary in length, diameter, and/or strength/material depending upon the size of the subject orchids. The Vandaceous orchids including Vanda, Ascocenda, Renanthera, Rhyncostylis, Aerides are monopodial orchids with a single stem and may be inclined to grow best when elevated and supported. A hanging rod may satisfy both by allowing hanging and allowing the stem to be secured to the hanging rod via various means including clips, string, wire and even soft window screen cut in strips and stapled secure. The rod may be sold straight and bent by the consumer. Bending at the top allows hanging as if a hook. Bending at the bottom after passing the hanging rod through the appropriate holes in the growth receptacle allows the rod to secure and suspend the base edges of the growth receptacle.

FIG. 2C depicts the split jardinière suspension and watering system of FIG. 2B with openings 105h to receive the hanging rod 105 therethrough. Openings 105h may be formed in just one half 102b of the jardinière if desired, or both to allow for placement of two handing rods 105 or selection of a desired location for the hanging rod 105. Therefore, it can be seen that the embodiment shown in FIGS. 2A to 2C has a receptacle that is open at the bottom and unable to hold soil. Although the receptacle is open at the bottom, it may be beneficial for the orchidist if the epiphytic orchid has reduced air flow to prevent unwanted drying of the roots; thus, the side portions of the receptacle may beneficially impede lateral/horizontal air flow reducing this component of evaporative air flow and may act a bit like a shell.

FIG. 2D depicts another example of a divided jardinière suspension and watering system having a bottom 104h with openings to allow roots of a vandaceous orchid to extend and/or grow therethrough according to some embodiments. As shown in this figure, the full bottom 104h may be formed along with one half of the full jardinière/receptacle. However, alternative embodiments are contemplated in which half bottoms, with or without openings, may be formed in both halves of the full jardinière/receptacle. In still other embodiments, the bottom may be removable.

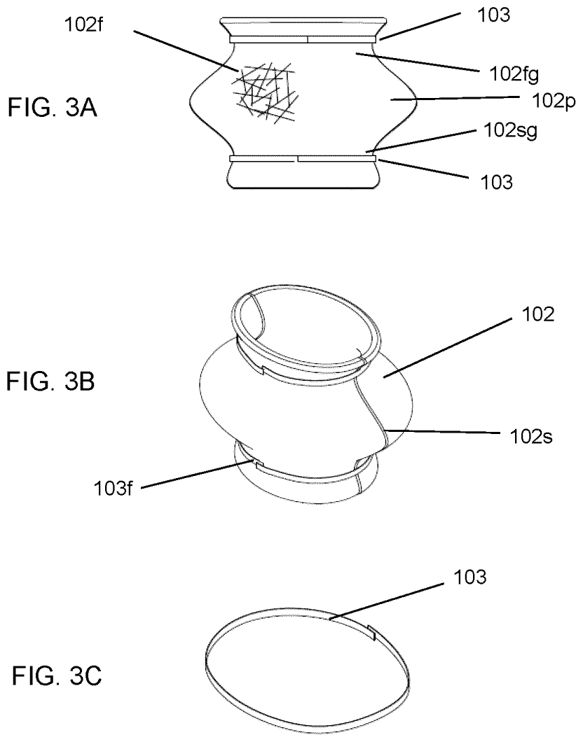

FIG. 3A depicts a jardinière suspension and watering system made from a fibrous material, such as tree fern, coconut husk, hemp, burlap, bark, or another fibrous, organic material. Any organic material comprising cellulose, particularly in strands, should be considered a fibrous material for purposes of this disclosure. Use of such material may be beneficial as it may render the system wholly or partially recyclable. In addition, the roots of a vandaceous orchid may be able to grow through a fibrous material such as these. In other embodiments, however, other materials may be used for the receptacle, such as pleated paper, composites of cloth, polyurethane foam, fiberglass, plastic mesh, or polyethylene, for example.

FIG. 3A also depicts a preferred shape for the receptacle. In particular, the receptacle may have an hourglass shape including one or more coupling receptacle grooves 102fg and 102sg and one or more receptacle protrusions 102p. The use of coupling receptacle grooves 102fg and 102sg may facilitate the use of coupling bands 103 or other coupling members, as previously described. Alternatively, to including protrusions 102p, however, in some embodiments, grooves or other coupling features for coupling bands may be formed with a relatively flat receptacle or a receptacle otherwise lacking protrusions 102p.

FIG. 3B is a perspective view of a fully coupled jardinière suspension and watering system with two pieces coupled together using a pair of coupling bands according to some embodiments. FIG. 3B also shows the seam 102s between the two receptacle pieces. In some embodiments, the seam 102s may be deliberately formed with a crack/space to allow for growth of roots therethrough. In some embodiments, the seam 102s may be deliberately formed with a crack/space to allow for repotting a plant with particularly long delicate roots wherein bending or forcing the root may cause breakage and damage to the plant, thus the roots may be allowed to protrude without bending from the side spaces or the bottom; this will allow plant growers to easily pot such a large plant fully lying on its side. In some embodiments, seam 102 may be formed with periodic openings therethrough for the same purpose.

FIG. 3C depicts an example of a coupling piece 103 comprising a coupling band for a jardinière suspension and watering system. As previously mentioned, coupling piece/band 103 may comprise a variety of materials, including iron, aluminum, or another formable metal, rubber or another elastic material, or another suitable material or coupling element. In some preferred embodiments, coupling pieces are preferably made of iron or stainless steel or alloys thereof and may be coated with silver or other metals or plastics that are nontoxic and/or antimicrobial. In some preferred embodiments, coupling pieces may measure about 2 mm in thickness, 1 cm in width and the distance around the narrowest portions of the unified growth receptacle portions plus about 5 cm to allow for variability in sizes and/or coupling tightness. In other embodiments coupling pieces may vary by 50% or 500% of that width with some additional or subtracted length.

In other embodiments coupling pieces may comprise solid or mesh bands of other metals including but not limited to stainless steel. In further embodiments, coupling pieces may comprise solid or mesh bands of organic matter including but not limited to hemp, cotton, natural rubber. In even further embodiments, coupling pieces may comprise solid or mesh bands of synthetic materials including but not limited to plastics and elastics. In some preferred embodiments, coupling pieces are coupled together via fasteners such as clamps, couplers, pins and holes and the like. In other embodiments, coupling pieces may comprise rope, string, belts or strap. Coupling pieces ends may join via various fastening methods including but not limited to holes, clips, and pins.

The receptacle of the embodiment shown in FIGS. 3a to 3c may be open at the bottom and may be unable to hold soil.

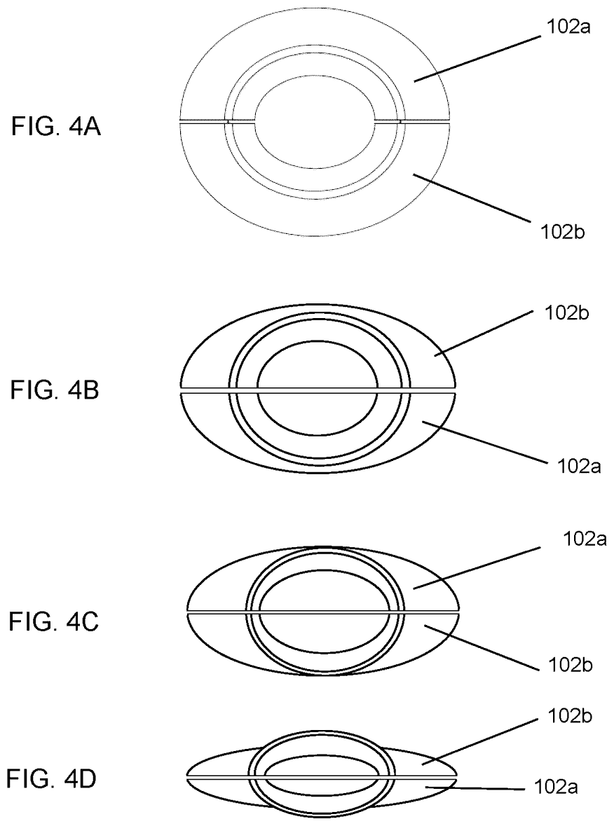

FIGS. 4a-4d are top plan views of various divided jardinière suspension and watering systems having different shapes according to some embodiments. Each of the receptacles formed by receptacle pieces 102a and 102b of these embodiments is formed with a non-circular elliptical, or at least substantially non-circular elliptical shape, at least along the mid-section of the receptacle (the section referred to previously as defining a protrusion). In alternative embodiments, one of the receptacle pieces may instead comprise a flat piece and the other piece may comprise a non-circular semi-elliptical shape in cross-section along a least a portion thereof (again, this may be the mid-section).

A typical circular pot for an orchid has a z-axis equal to the x-axis which in the case of Vandaceous orchids may cost unnecessary space and conflict with the aesthetics of a linear plant. A cross-sectionally elliptical potting system may be advantageous not only from space saving, especially in a home but from an aesthetic sense in that an ellipse has a minimized z-axis (less depth) matching the orchid's style of growth and habitus. Thus, providing an elongated, non-circular, elliptical shape like this may be beneficial for the growth and/or aesthetics of vandaceous orchid growing.

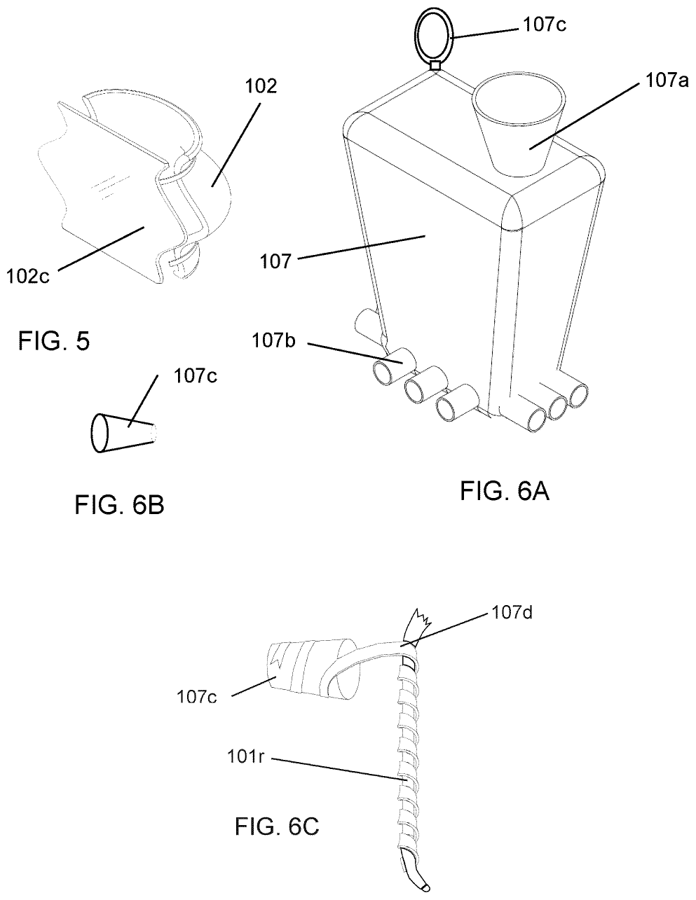

FIG. 5 depicts a divided jardinière suspension and watering system having one shaped piece 102, which may have any of the shapes previously described, and one flat piece 102c according to some embodiments. Any of the receptacle coupling bands or other coupling pieces may be used to couple these two pieces together. However, due to the flat surface of piece 102c, it may be desirable to instead use one of the more flexible pieces previously mentioned, such as an elastic or rubber coupling piece. Having a flat piece as a side may allow optimal positioning against a wall or other flat structure for aesthetics or space saving. In some embodiments, the flat piece 102c may comprise a transparent plastic including but not limited to polycarbonate or acrylic. In other embodiments, the flat piece 102c may be attached to the shaped piece 102 via moveable hinges such that the system may be periodically removed from the wall and subject to inspection or maintenance or watering for example. Having a flat piece as a side may allow novel uses for repeated access to a VEOs root system such as being able to ‘Bonsai’ the roots by weaving them or training them to grow in patterns such as a braid. The receptacle shown in FIG. 5 is open at the bottom and is unable to hold soil.

FIG. 6A depicts a watering manifold 107 for a jardinière suspension and watering system according to some embodiments. Watering manifold 107 comprises an intake port 107a for receiving water and potentially other nutrients for the orchid. A chamber is defined within the manifold to store such water and/or nutrients. A manifold coupling member 107c, such as a ring, may be provided, which may facilitate positioning of the manifold 107 within, or potentially adjacent but outside of, the receptacle. In some embodiments, the aforementioned hanging rod may extend through the manifold coupling member/ring. In some embodiments, watering manifold 107 may comprise a rigid plastic, such as polyurethane. In other embodiments, watering manifold 107 may comprise a flexible synthetic material, such as silicone, which may be advantageous in that it will compress to fit into spaces or against objects with less trauma to delicate roots than a rigid material.

Watering manifold 107 further comprises a plurality of output ports 107b, which may extend about one or more sides of the manifold 107, preferably about the bottom portion of the manifold 107.

In preferred embodiments, each of the output ports 107b may comprise a circular opening so as to receive a cork or other stopper 107c therein. FIG. 6B depicts an example of such a stopper 107c. As shown in FIG. 6B, preferably, stoppers 107c comprise a tapered shape to allow for wedging them into an output port 107b of watering manifold 107.

FIG. 6C depicts a water delivery member 107d, which depends from the watering manifold 107. The water delivery member 107d contacts the root, for example by being wrapped around the root, so that water is delivered gravitationally to the root. The water delivery member 107d may comprise, for example, a ribbon or ribbon-like structure, which may comprise, for example, a cloth material or another similar material that allows water to be absorbed and slowly travel along the length of the dependently/inferiorly placed ribbon 107d to be delivered to one or more roots 101r of an orchid, as shown in FIG. 6C. As also shown in FIG. 6C, the opposite end of the water delivery member/ribbon 107d from the end wrapped about root 101r may be wrapped around a stopper 107c. In this manner, stoppers 107c may be inserted into their respective output ports 107b to prevent water from rushing/spilling out while allowing a small but slow and steady flow to be delivered via gravitational and/or capillary action forces through the water delivery member/ribbon 107d. In some implementations, the end of the water delivery member/ribbon 107d may be wrapped about the stopper 107c or, alternatively, may extend into the chamber of manifold 107. A gravitationally dependent and/or capillary based wrapped wicking system of ribbons for vanda roots may alleviate evaporation concerns. The system may also have the advantage of wrapping just a few roots to continually deliver water to a SLV without having to water the SLV via spray or bathing as described above. The forces of capillary action through a porous wick which may include the forces of adhesion, cohesion, and surface tension may not overcome evaporation and gravity over a given time in a system open to the air. Thus, a gravitationally dependent wick wrapped around an SLV root may deliver water to a length of a root before evaporation would remove the water, as opposed to an open-air wick oriented superiorly/above a water source. A prolonged source of watering of one or more roots in such a fashion may benefit an orchidist who may wish to take a prolonged vacation or avoid watering for some time.

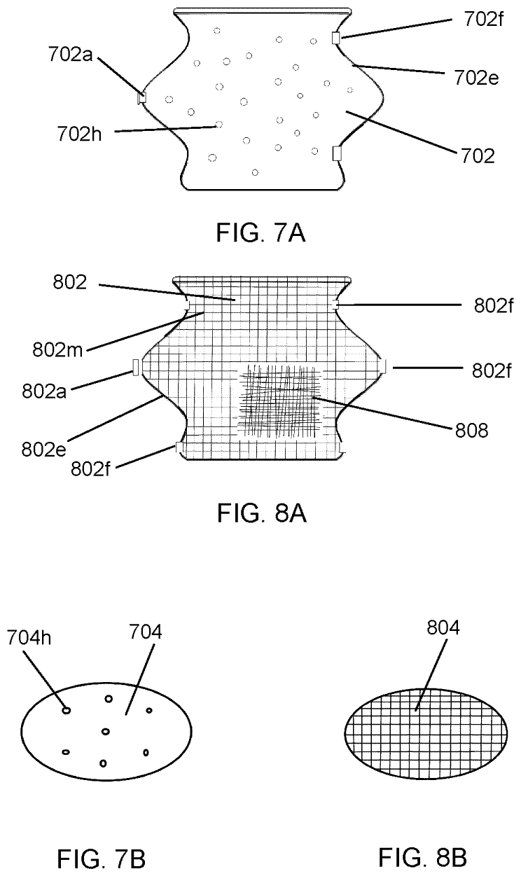

FIG. 7A depicts an embodiment of one piece 702 of a divided jardinière suspension system, which piece 702 may comprise, for example, a plastic material. In some embodiments, the shell of piece 702 may comprise a synthetic material, including but not limited to plastics, fiberglass, nylons, acrylics and any other synthetics nontoxic to VEOs. In further embodiments, the shell of 702 may comprise organic and/or natural materials including but not limited to bonded wood fibers, hemp, stiffened rope, stiffened linen and the like. In some embodiments, receptacle piece 702 of a divided jardinière suspension system may comprise a hinge 702a, which may affix the receptacle piece to an adjoining formed or flat receptacle and act in a hinge fashion. A fastener 702f, such as a clamp, may releasably affix the receptacle piece to an adjoining formed or flat receptacle on the opposite side of the edge 702e of receptacle piece 702. Openings 702h may be formed on one or both of the receptacle pieces of receptacle 702 to allow the passage of a hanging rod or air (in the case of aeration which may benefit the epiphytic plant).

Preferably, edge 702e comprises a more rigid and strong material than the remainder of the opposing receptacle walls defining a receptacle piece, which may serve as a foundation for mounting a hinge, clasp, or other fastener and/or the like, which may be permanently coupled or releasably coupled with edge 702e if desired. In some embodiments, edge 702e may therefore comprise, for example, a rigid and/or deformable/moldable metal, plastic, fiberglass, wood, epoxy, or the like to serve as a frame for the preferably mesh material defining the adjacent walls.

FIG. 7B depicts an embodiment of an insertable bottom piece 704 of a divided jardinière suspension system with holes 704h.

FIG. 8A depicts an embodiment of one piece 802 of a divided jardinière suspension system comprised of metal woven mesh 802m also showing some attached natural fibrous material 808, such as coconut palm tree bark husk, incorporated into piece 802. Vandaceous epiphytic orchids (VEOs) may also be grown in other natural fibrous materials, including but not limited to dried tree fern, some processed mosses, wooden sticks and bark strips. If such natural fibrous materials are available in sheet form, such as palm tree bark husk, they may be affixed to the outside of the metal mesh for a more natural look by a variety of fastening means including but not limited to clips, pins, staples and the like. Synthetic fibrous materials may be affixed to the inside of the mesh as well. In some embodiments, the mesh may comprise metals including but not limited to stainless steel, steel alloys, aluminum and any other nontoxic metal to VEOs. In other embodiments, the mesh may comprise synthetic materials including but not limited to plastics, fiberglass, and any other synthetic material nontoxic metal to VEOs. In further embodiments, the mesh may comprise organic and/or natural materials including but not limited to wood fibers, hemp, stiffened rope, stiffened linen and the like. Suitable dimensions for the individual holes in the mesh 802m may be about 10 mm in some embodiments as most VEO roots do not exceed this size. Mesh sizes smaller than 2 mm may impede the penetration of roots which may not be undesirable as the system may be used to ‘train’ the roots to grow in a ball or down the area of a missing base if desired. Depending of the size of the growing media, larger mesh dimensions may be satisfactory as long as they retain a desirable portion of the of the media, for example large chunks of tree fern.

In some embodiments, receptacle piece 802 of a divided jardinière suspension system may comprise hinge 802a, which may affix the receptacle piece to an adjoining formed or flat receptacle and act in a hinge fashion. A fastener 802f may releasably affix the receptacle piece to an adjoining formed or flat receptacle on the opposite side of the edge 802e of receptacle piece 802.

FIG. 8B depicts an embodiment of an optional insertable bottom piece 804 of a divided jardinière suspension system, which may comprise a metal woven mesh.

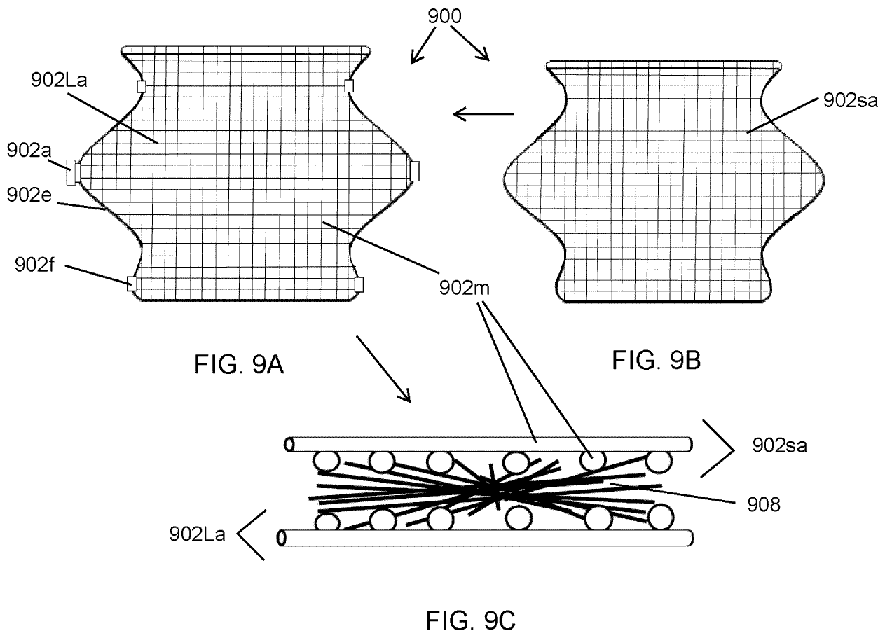

FIG. 9A depicts an alternative embodiment in which each half of the complete receptacle may itself be defined by two pieces. Thus, FIGS. 9a and 9b depict two pieces that may be coupled together to define one half, or at least approximately one half, of a complete receptacle. The other half or portion (not shown) of the complete receptacle may therefore have a similar appearance and be made up of two other pieces sandwiched together. Alternatively, however, one side/half of a complete receptacle may be defined by two sandwiched and/or nested pieces and the other side/half may be defined by a single piece, such as, for example, a flat, transparent piece or, in other embodiments, a shaped piece without a sandwiched/nested feature/piece.

In FIGS. 9A and 9B, one piece 902La of one half/portion of a divided jardinière suspension system 900 may comprise of metal woven mesh. In some embodiments, piece 902La may be larger than the accompanying piece 902sa and may be designed to fit inside the contours of the larger piece 902La so that one or more of the walls of the complete receptacle may be defined, at least in part, by a sandwiched configuration having two walls defined by a mesh material with a suitable material, preferably one that allows orchid root growth, such as a fibrous material, sandwiched therebetween.

Pieces 902La and 902sa may be designed to fit together in such a fashion that any fibrous or natural material between them may be sandwiched. Fasteners 902f on larger piece 902La may be used to affix the smaller piece 902sa to 902La or to affix 902La to its complimentary piece forming a piece of the system that may be coupled with another sandwiched pair of pieces to form the entire receptacle.

The mesh of this system may comprise, for example, a metal woven mesh 902m. In other contemplated embodiments, the mesh of the system may comprise metal welded mesh. In some embodiments, the mesh may comprise metals including but not limited to stainless steel, steel alloys, aluminum and any other nontoxic metal to VEOs. In other embodiments, the mesh may comprise synthetic materials, including but not limited to plastics, fiberglass, and any other synthetic material nontoxic metal to VEOs. In further embodiments, the mesh may comprise organic and/or natural materials, including but not limited to wood fibers, hemp, stiffened rope, stiffened linen and the like. Suitable dimensions for the individual holes in the mesh 902m may be about 10 mm as most VEO roots do not exceed this size. In other contemplated embodiments, mesh sizes may range from about 1 mm to about 30 mm. In some embodiments, receptacle piece 902La of a divided jardinière suspension system may comprise a hinge 902a or another suitable element to facilitate coupling, which may affix the receptacle piece to an adjoining formed or flat receptacle and act in a hinge fashion.

A fastener 902f may releasably affix the receptacle piece defined by sandwiched pieces 902sa and 902La to an adjoining formed or flat receptacle piece on the opposing side of the edge 902e of an opposing receptacle piece. In some embodiments, edge 902e may be made of thickened material to facilitate affixation or clamping or provide sturdiness for the product; mesh may or may not be affixed to edge 902e via, for example, welding. Like the embodiment shown in FIG. 8A, the embodiment depicted in FIGS. 9a-c may be used with an optional insertable bottom piece 804 of a divided jardinière suspension system and may, for example, comprise a metal woven mesh.

Piece 902sa, which may comprise a smaller piece than piece 902La, of a divided jardinière suspension system depicted in FIG. 9B may comprise a similar material to that of larger piece 902La. In other embodiments, piece 902sa of a divided jardinière suspension system depicted in FIG. 9B may comprise a dissimilar material to that of larger piece 902La. For example, piece 902La may comprise a metal mesh and piece 902sa may comprise a plastic or organic mesh. In embodiments in which these two pieces differ in size, the smaller piece may be configured to fit inside and/or closely approximate the larger piece such that a suitable material may be sandwiched in between. Affixation between the two may commence once the sandwiched matter is satisfactorily located in its resting place.

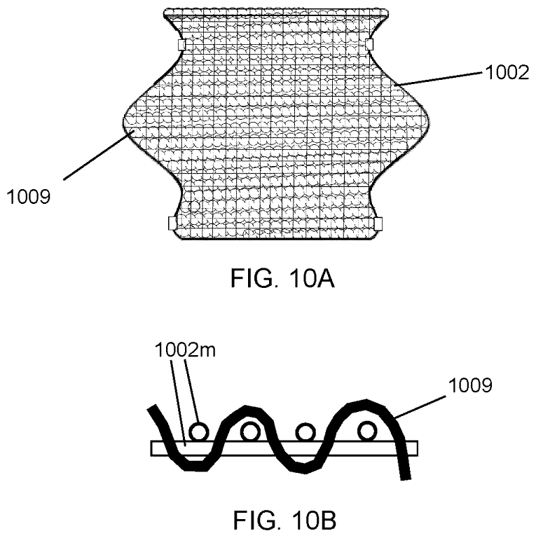

FIG. 9C is a cross sectional view depicting the combination of piece 902La and piece 902sa wherein a fibrous material 908 of a fibrous material, such as coconut palm tree bark husk, is being sandwiched and/or compressed in between the two pieces to define a wall for a complete receptacle that allows growth of roots therethrough. It should be understood that, although FIGS. 7a-9b are two-dimensional views, the three-dimensional shape of the completed receptacle defined by the various sandwiched and/or unitary receptacle pieces may have a similar shape to those previously described, such as an hourglass shape having recessed regions for receipt of suitable bands or other fasteners therein. FIG. 10A illustrates another alternative receptacle piece 1002 that may define a portion of a complete receptacle for a vandaceous orchid. Piece 1002 comprises an elongated fibrous member 1009, such as a rope or string, which may be weaved in and out of openings of a mesh material, such as preferably a metal mesh material, that defines the wall of piece 1002. It should be understood that both pieces of the complete receptacle may therefore be defined by such a woven fibrous material and then may be coupled together as previously described, such as using bands, clasps, clamps, hinges, and/or other fasteners.

FIG. 10B is a close-up view of a portion of receptacle piece 1002 illustrating how the elongated fibrous member 1009 is weaved in and out of the mesh 1002m defining receptacle piece 1002.

1. A jardinière suspension system for watering aerial roots of a vandaceous orchid, comprising:
a first receptacle piece;
a second receptacle piece coupleable with the first receptacle piece to form a complete receptacle for growing a vandaceous orchid therein, wherein the complete receptacle comprises a non-circular elliptical or non-circular semi-elliptical shape in cross-section, wherein the complete receptacle is open at the bottom and unable to hold soil;
at least one coupling piece for coupling the first receptacle piece to the second receptacle piece; and
a watering manifold having at least one watering outtake port for delivery of water to aerial roots of the vandaceous orchid; and
at least one water delivery member is configured to extend from the watering manifold, wherein any one water delivery member of the at least one water delivery member is configured to be wrapped spirally about an individual aerial root of the vandaceous orchid to deliver water continuously from the watering manifold via capillary action; and
wherein the at least one water delivery member is configured to depend from the manifold, whereby water passes through the at least one water delivery member gravitationally from the manifold, and wherein the at least one water delivery member is configured to wrap spirally around a vandaceous orchid aerial root and wherein the at least one water delivery member is configured to directly contact vandaceous orchid aerial roots.

2. The jardinière suspension system of claim 1, further comprising a manifold coupling member configured to hang the watering manifold within or adjacent to the complete receptacle.

3. The jardinière suspension system of claim 1, wherein the watering manifold comprises a flexible synthetic material configured to compressively fit within the complete receptacle.

4. The jardinière suspension system of claim 1, wherein the watering manifold comprises a plurality of output ports.

5. The jardinière suspension system of claim 4, wherein the plurality of output ports are positioned about a bottom portion of the watering manifold.

6. The jardinière suspension system of claim 1, further comprising a stopper configured to be received in the at least one watering outtake port wherein the stopper comprises a tapered shape configured to be wedged into the at least one watering outtake port.

7. The jardinière suspension system of claim 6, wherein the at least one water delivery member comprises a ribbon or ribbon-like structure.

8. The jardinière suspension system of claim 5, wherein the at least one water delivery member is configured to absorb water from a chamber of the watering manifold and deliver water to aerial roots of the vandaceous orchid via the at least one watering outtake port.

9. A jardinière suspension arrangement comprising:
a vandaceous orchid;
a first receptacle piece;
a second receptacle piece coupled with the first receptacle piece to form a complete receptacle the vandaceous orchid being arranged within the complete receptacle, wherein the complete receptacle comprises a non-circular elliptical or non-circular semi-elliptical shape in cross-section;
at least one coupling piece coupling the first receptacle piece to the second receptacle piece;
a watering manifold having at least one watering outtake port for delivery of water to aerial roots of the vandaceous orchid; and
at least one water delivery member configured to extend from the watering manifold and be wrapped about one or more roots of the vandaceous orchid to deliver water continuously from the watering manifold via capillary action;
wherein the at least one water delivery member is wrapped about one or more aerial roots of the vandaceous orchid to deliver water continuously.

10. The jardinière suspension arrangement of claim 9, wherein the watering manifold comprises a plurality of output ports.

11. The jardinière suspension arrangement of claim 10, wherein the plurality of output ports are positioned about a bottom portion of the watering manifold.

12. The jardinière suspension arrangement of claim 9, wherein the at least one water delivery member comprises a ribbon or ribbon-like structure.

13. The jardinière suspension arrangement of claim 9, wherein the at least one water delivery member extends into a chamber of the watering manifold through the at least one watering outtake port, and a stopper is positioned in the at least one watering outtake port.

14. The jardinière suspension arrangement of claim 9, wherein the at least one water delivery member is configured to absorb water from a chamber of the watering manifold and deliver water to aerial roots of the vandaceous orchid via the at least one watering outtake port.

15. A method of watering a vandaceous orchid, comprising:
providing a first receptacle piece;
providing a second receptacle piece;
providing at least one coupling piece for coupling the first receptacle piece to the second receptacle piece;
coupling the first receptacle piece with the second receptacle piece by means of the coupling piece to form a complete receptacle for growing a vandaceous orchid therein, wherein the complete receptacle comprises a non-circular elliptical or non-circular semi-elliptical shape in cross-section;
providing a watering manifold having at least one watering outtake port for delivery of water to aerial roots of the vandaceous orchid; and
providing at least one water delivery member configured to extend from the watering manifold to deliver water continuously from the watering manifold via capillary action;
wrapping the at least one water delivery member about one or more aerial roots of the vandaceous orchid.

16. The method claim 15, wherein the watering manifold comprises a plurality of output ports.

17. The method of claim 16, wherein the plurality of output ports are positioned about a bottom portion of the watering manifold.

18. The method of claim 15, wherein the at least one water delivery member comprises a ribbon or ribbon-like structure.

19. The method of claim 15, comprising arranging the at least one water delivery member so that it extends into a chamber of the watering manifold through the at least one watering outtake port, and positioning a stopper in the at least one watering outtake port.

20. The method of claim 15, wherein the at least one water delivery member is configured to absorb water from a chamber of the watering manifold and deliver water to aerial roots of the vandaceous orchid via the at least one watering outtake port.
